(19) United States
(12) Patent Application Publication
(10) Pub. No.: US 2016/0357225 A1
(43) Pub. Date: Dec. 8, 2016

(54) ELECTRONIC DEVICE

(71) Applicant: Acer Incorporated, New Taipei City (TW)

(72) Inventors: Pao-Min Huang, New Taipei City (TW); Chia-Bo Chen, New Taipei City (TW); Cheng-Mao Chang, New Taipei City (TW); Pao-Ching Huang, New Taipei City (TW); Tai-Lan Chu, New Taipei City (TW); Yi-Chang Yeh, New Taipei City (TW); Chia-Ming Chang, Taoyuan (TW)

(21) Appl. No.: 15/165,490

(22) Filed: May 26, 2016

(30) Foreign Application Priority Data
Jun. 5, 2015 (TW) 104118329

(51) Int. Cl. G06F 1/16; E05D 11/06; E05D 3/12; E05D 3/18

(52) U.S. Cl. CPC G06F 1/1681; E05D 3/18; E05D 11/06; E05D 3/12; G06F 1/1616

(57) ABSTRACT

An electronic device including a lower body, an upper body, a rotating assembly, a sliding assembly and a stopping assembly is provided. The upper body is disposed above the lower body. The rotating assembly is disposed between the upper body and the lower body, so that the upper body is pivotally disposed on the lower body. The sliding assembly is disposed between the rotating assembly and the lower body, so that the rotating assembly is slidably disposed on the lower body. The stopping assembly is disposed on the lower body, so as to fix the sliding assembly when the upper body rotates relative to the lower body through the rotating assembly and release the sliding assembly until the upper body rotates to a predetermined angle, thereafter the upper body and the rotating assembly are adapted to slide relative to the lower body through the sliding assembly.

### CROSS-REFERENCE TO RELATED APPLICATION

This application claims the priority benefit of Taiwan application serial no. 104118329, filed on Jun. 5, 2015. The entirety of the above-mentioned patent application is hereby incorporated by reference herein and made a part of this specification.

### BACKGROUND OF THE DISCLOSURE

1. Field of the Disclosure

The present invention relates to an electronic device.

2. Description of Related Art

In recent years, along with increasing development of science and technology industry, electronic devices such as notebook computers, tablet personal computers (PCs) and smart phones are frequently used in daily life. Types and functions of the electronic devices become more and more diversified, and the electronic devices become more popular due to convenience and practicality thereof, so as to be applied to different usages according to user's requirement.

Taking a notebook computer as an example, the electronic device may have an upper body and a lower body, and the upper and lower bodies are pivotally disposed together through a rotating assembly (e.g., a hinge). As such, the upper body may rotate relative to the lower body through the rotating assembly and is expanded, so as to expose a display surface which is located on the upper body. However, this kind of electronic device may adjust the using angle between the upper body and the lower body as required, but it only has one kind of using mode. Therefore, in current operating method, by turning over the upper body and stacking it on the lower body, the electronic device is used as a tablet computer. In current operating method, the upper body is pivotally disposed, with the display surface facing outside, on the lower body, so that the electronic device is used as a tablet computer when the upper body is stacked on the lower body, and when the upper body slides and is expanded relative to the lower body and stands on the lower body, the electronic device is used as a notebook computer. This operating method may often cause the display surface damaged. In addition, in current operating method, the upper body is pivotally disposed, with the display surface facing inside, on the lower body, and the upper body rotates along a same shaft direction into 360 degrees to the back surface of the lower body and the display surface faces outside, or the upper body first rotates along a first shaft direction relative to the lower body and stands on the lower body and then further rotates along a second shaft direction relative to the lower body and the display surface faces outside, and then rotates back along the first shaft direction and is stacked on the lower body. However, in the abovementioned operating methods, rotating assembly having complicated structures are necessary to achieve rotation of multiple rotating shafts, and the operation is complicated.

### SUMMARY OF THE DISCLOSURE

The disclosure provides an electronic device, the upper body and the lower body thereof may rotate and slide relatively to switch among using modes, and the rotating action and the sliding action thereof have an execution sequence, facilitating the electronic device to have a superior operating method.

The electronic device of the disclosure includes a lower body, an upper body, a rotating assembly, a sliding assembly and a stopping assembly. The upper body is disposed above the lower body. The rotating assembly is disposed between the upper body and the lower body, so that the upper body is pivotally disposed on the lower body. The sliding assembly is disposed between the rotating assembly and the lower body, so that the rotating assembly is slidably disposed on the lower body. The stopping assembly is disposed on the lower body and corresponding to the sliding assembly, so as to fix the sliding assembly when the upper body rotates relative to the lower body through the rotating assembly and release the sliding assembly until the upper body rotates to a predetermined angle, thereafter the upper body and the rotating assembly are adapted to slide relative to the lower body through the sliding assembly.

In light of the above, in the electronic device of the disclosure, the upper body may rotate relative to the lower body through the rotating assembly, and the rotating assembly is disposed on the sliding assembly, so that the rotating assembly and the upper body may slide relative to the lower body through the sliding assembly. In other words, the electronic device of the disclosure adopts the rotating assembly which can slide. Furthermore, the electronic device adopts the stopping assembly to fix the sliding assembly when the upper body rotates relative to the lower body through the rotating assembly, until the upper body is in a predetermined condition (e.g., rotated to a predetermined angle) the sliding assembly is then released. Accordingly, in the electronic device of the disclosure, the upper body and the lower body thereof may rotate and slide relatively to switch among using modes, and the rotating action and the sliding action thereof have an execution sequence, facilitating the electronic device to have a superior operating method.

To make the above features and advantages of the disclosure more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a schematic top view illustrating an electronic device according to an exemplary embodiment of the disclosure.

FIG. 2 through FIG. 4 are side views schematically illustrating that the electronic device switches among the using modes.

FIG. 5 is a schematic side view illustrating the electronic device of FIG. 1.

FIG. 6 is a partial view schematically illustrating that the electronic device of FIG. 5 switches among the using modes.

### DESCRIPTION OF THE EMBODIMENTS

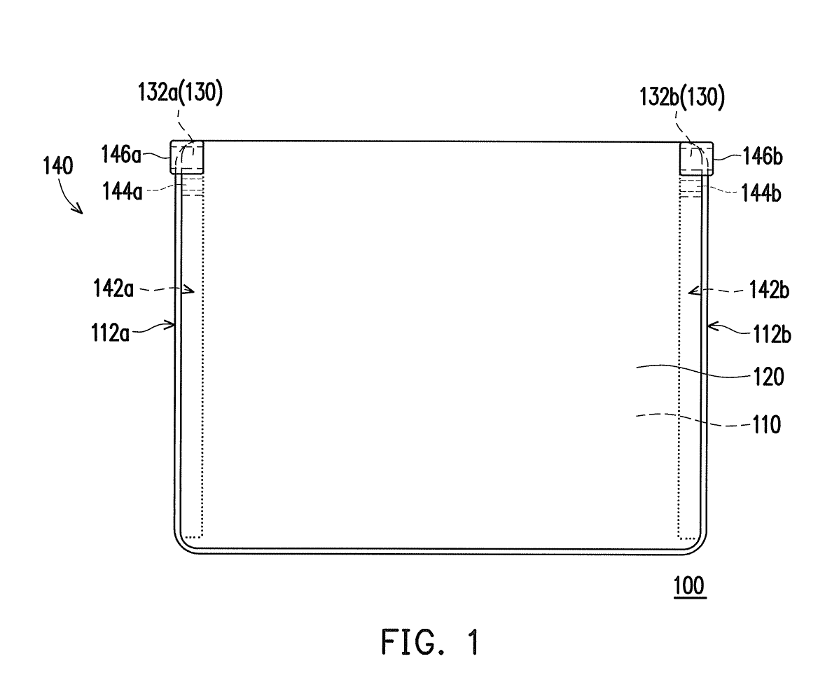

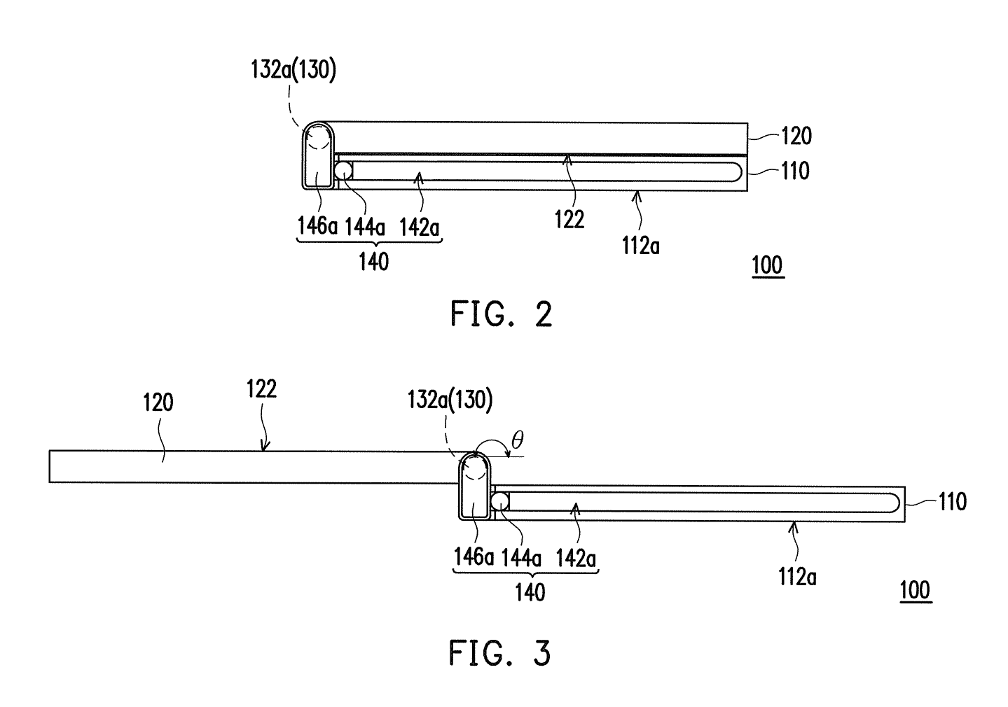

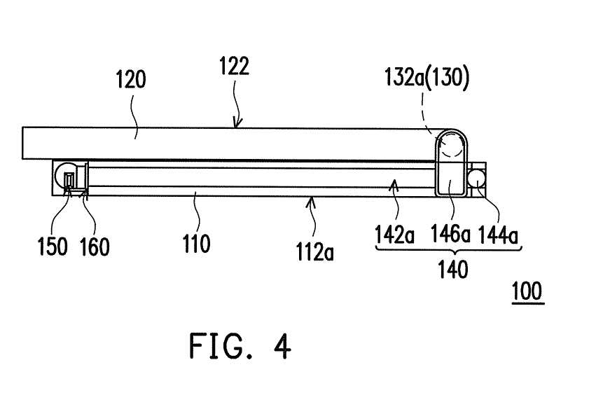

FIG. 1 is a schematic top view illustrating an electronic device according to an exemplary embodiment of the disclosure. FIG. 2 through FIG. 4 are side views schematically illustrating that the electronic device switches among the using modes. Referring to FIG. 1 and FIG. 2, in the present embodiment, an electronic device 100 includes a lower body 110, an upper body 120, a rotating assembly 130 and a sliding assembly 140. The upper body 120 is disposed above the lower body 110. The rotating assembly 130 is disposed between the upper body 120 and the lower body 110, so that the upper body 120 is pivotally disposed on the lower body 120. As such, the upper body 120 may rotate relative to the lower body 110 through the rotating assembly 130 and is expanded, as shown in FIG. 2 and FIG. 3. In addition, the sliding assembly 140 is disposed between the rotating assembly 130 and the lower body 110, so that the rotating assembly 130 is slidably disposed on the lower body 110. As such, after the upper body 120 is rotated relative to the lower body 110 through the rotating assembly 130, the rotating assembly 130 may slide relative to the lower body 110 through the sliding assembly 140, and drive the upper body 120 to stack onto the lower body 110 again, as shown in FIG. 3 and FIG. 4. Accordingly, the upper body 120 and the lower body 110 of the electronic device 100 may rotate and slide relatively to switch the using modes.

For example, in the present embodiment, the display surface 122 of the upper body 120 is hidden between the upper body 120 and the lower body 110, and may be exposed when the upper body 120 is rotated relative to the lower body 110 and expanded, then the electronic device 100 is used as a notebook computer. In addition, after the upper body 120 is rotated relative to the lower body 110, the upper body 120 may be stacked onto the lower body 110 again with the display surface 122 facing outside through sliding, so that the electronic device 100 is used as a tablet computer. As such, the upper body 120 and the lower body 110 of the electronic device 100 may rotate and slide relatively and switch to the notebook computer using mode or the tablet computer using mode, however the disclosure does not limit the type of electronic device, and it may be adjusted as required.

Specifically, in the present embodiment, the rotating assembly 130 includes a pair of rotating shafts 132a and 132b disposed on the two opposite sides of the lower body 110, and correspondingly connected to the two opposite sides of the upper body 120, so that the upper body 120 is pivotally disposed on the lower body 110. In other words, the rotating shafts 132a and 132b are correspondingly fixed on the two opposite sides of the lower body 110, and pivoted to the two opposite sides of the upper body 120. Additionally, the sliding assembly 140 includes a pair of slide rails 142a and 142b, a pair of rolling wheels 144a and 144b, and a pair of connecting elements 146a and 146b. The slide rails 142a and 142b are disposed on the two opposite side surfaces 112a and 112b of the lower body 110. The rolling wheels 144a and 144b are disposed within the slide rails 142a and 142b, and may correspondingly roll within the slide rails 142a and 142b. The connecting elements 146a and 146b are disposed on the two opposite side surfaces 112a and 112b of the lower body 110. The rolling wheels 144a and 144b are disposed on the connecting elements 146a and 146b, and the rotating shafts 132a and 132b are correspondingly connected to the rolling wheels 144a and 144b by disposing on the connecting elements 146a and 146b. In other words, each of the rotating shafts (e.g., the rotating shaft 132a ) and the corresponding rolling wheel (e.g., the rolling wheel 144a) are disposed at the two opposite ends of the corresponding connecting element (e.g., the connecting element 146a). However, the disclosure does not limit the numbers of the rotating shafts, the slide rails, the rolling wheels and the connecting elements, and does not limit the components of the rotating assembly 130 and the sliding assembly 140.

From the abovementioned, the upper body 120 may rotate relative to the lower body 110 through the rotating shafts 132a and 132b of the rotating assembly 130, and the rotating shafts 132a and 132b of the rotating assembly 130 may be connected to the corresponding rolling wheels 144a and 144b through the connecting elements 146a and 146b of the sliding assembly 140, and may be slidably disposed on the lower body 110 through embedding the corresponding rolling wheels 144a and 144b into the corresponding slide rails 142a and 142b. Further, after the upper body 120 is rotated relative to the lower body 110 through the rotating shafts 132a and 132b, the rotating shafts 132a and 132b further slide relative to the lower body 110 through the rolling wheels 144a and 144b, which are also connected to the connecting elements 146a and 146b, correspondingly rolling within the slide rails 142a and 142b, thereby the upper body 120 is also driven to slide relative to the lower body 110. Accordingly, the user may switch the using modes of the electronic device 100 as required (those three using modes are shown in FIG. 2 through FIG. 4). Moreover, the slide rails 142a and 142b, the rolling wheels 144a and 144b and the connecting elements 146a and 146b of the sliding assembly 140 are disposed on the two opposite side surfaces 112a and 112b of the lower body 110, thus the disposing of the sliding assembly 140 does not increase the thickness of the electronic device 100, advantaging development of thinning trends of the electronic device 100. However, the disposing location of the sliding assembly 140 is not limited in the disclosure.

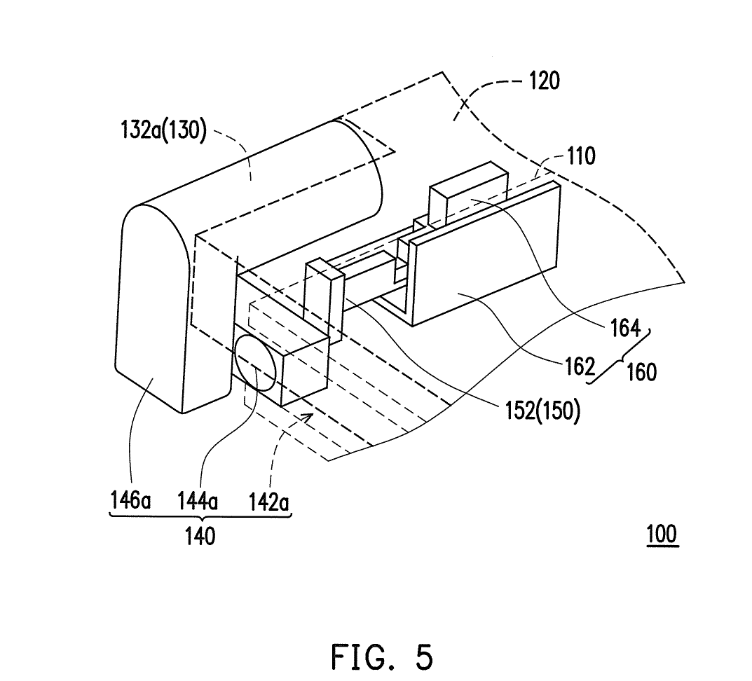

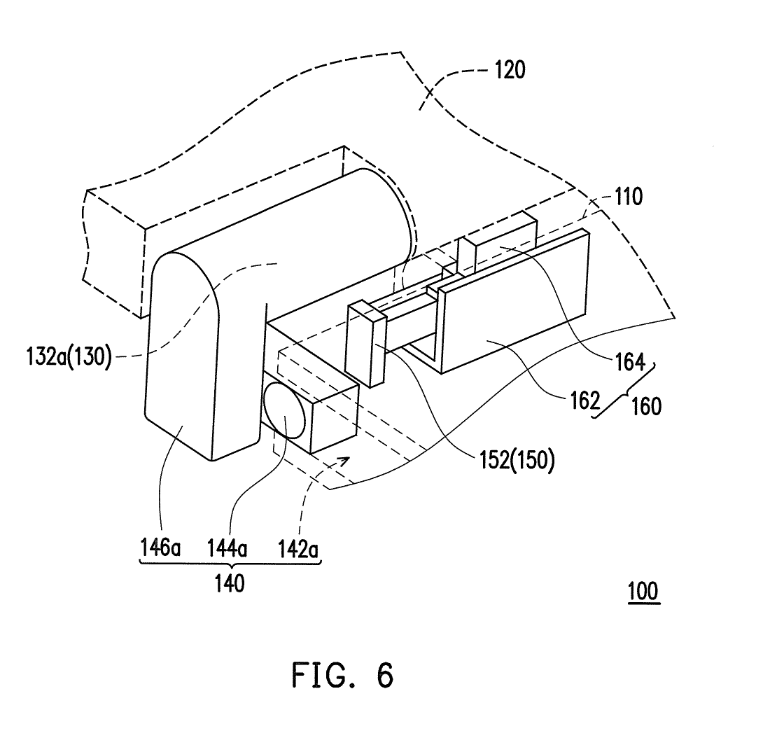

FIG. 5 is a schematic side view illustrating the electronic device of FIG. 1. FIG. 6 is a partial view schematically illustrating that the electronic device of FIG. 5 switches among the using modes. An example is exemplarily described herein with FIG. 5 and FIG. 6 which illustrate one side of the electronic device 100. Referring to FIG. 1, FIG. 2 and FIG. 5, in the present embodiment, in order to achieve a good operating method when the electronic device 100 is switched to the using modes, the action of the upper body 120 rotating relative to the lower body 110 and the action of the upper body 120 sliding relative to the lower body 110 may preferably have an execution sequence, namely, before the upper body 120 is rotated to the predetermined angle θ relative to the lower body 110, the slide assembly 140 is in a fixed status, and the upper body 120 slides relative to the lower body 110 merely after the upper body 120 is rotated to the predetermined angle θ relative to the lower body 110. Accordingly, in the present embodiment, the electronic device 100 includes a stopping assembly 150 and a trigger assembly 160, so as to individually execute the rotation action and the sliding action. For the sake of more clearly showing the action relationship between each component of the electronic device 100, the lower body 110 and the upper body 120 are shown in dashed-lines in FIG. 5 and FIG. 6.

Specifically, in the present embodiment, the stopping assembly 150 is disposed on the lower body 110 and corresponds to the sliding assembly 140, so as to fix the sliding assembly 140 when the upper body 120 rotates relative to the lower body 110 through the rotating assembly 130 and release the sliding assembly 140 until the upper body 120 rotates to the predetermined angle θ, thereafter the upper body 120 and the rotating assembly 130 slide relative to the lower body 110 through the sliding assembly 140. The trigger assembly 160 is disposed on the lower body 110 and connected to the stopping assembly 150, so as to be triggered when the upper body 120 rotates to the predetermined angle θ and drive the stopping assembly 150 to release the sliding assembly 140. In other words, before the upper body 120 is rotated to the predetermined angle θ relative to the lower body 110, the sliding assembly 140 is interfered by the stopping assembly 150 and in a fixed status, and until after the upper body 120 is rotated to the predetermined angle θ relative to the lower body 110 and the trigger assembly 160 is triggered, the stopping assembly 150 may release the sliding assembly 140 through the driving of the trigger assembly 160, thereby the upper body 120 and the rotating assembly 130 may then slide relative to the lower body 110 through the sliding assembly 140. As such, the rotation action and the sliding action of the upper body 120 have an execution sequence, advantaging that the electronic device 100 has a good operating method when switching among the using modes.

Moreover, in the present embodiment, the stopping assembly 150 includes a pair of pins 152 (one of the pins 152 is shown in FIG. 5). The pins 152 are disposed on the lower body 110, for example, disposed in an accommodating space (not shown) in the internal of the lower body 110 and located on two opposite sides of the lower body 110 (one of the sides is shown in FIG. 5) and corresponding to the rolling wheel 144a, so as to fix the sliding assembly 140 by interfering the rolling wheel 114a when the upper body 120 is rotated relative to the lower body 110 through the rotating assembly 130. In other words, the pin 152 may prop against the rolling wheel 144a and may even be inserted into the rolling wheel 144a further, so as to prevent the rolling wheel 144a rolls within the slide rail 142a, thereby to fix the sliding assembly 140 through the stopping assembly 150. However, the disclosure does not limit the number of the pins 152, neither limit the embodiments of the stopping assembly 150, it may alter according to actual requirement.

In addition, in the present embodiment, the trigger assembly 160 includes an electromagnetic element 162 and a detecting element 164. The electromagnetic element 162 is a solenoid valve, for example, disposed on the lower body 110 and connected to the stopping assembly 150. The detecting element 164 is a sensor, for example, disposed on the lower body 110 and connected to the electromagnetic element 162, but the types of the electromagnetic element 162 and the detecting element 164 are not limited in the disclosure. Accordingly, the detecting element 164 may detect whether the upper body 120 is rotated to the predetermined angle θ, and the electromagnetic element 162 may control the stopping assembly 150 to fix or release the sliding assembly 140 according to the detected result of the detecting element 164, for example, control the pin 152 to approach to or get away from the rolling wheel 144a. Accordingly, when the detecting element 164 detects that the upper body 120 is rotated to the predetermined angle θ during the process of the upper body 120 rotating relative to the lower body 110, the electromagnetic element 162 controls the stopping assembly 150 to release the sliding assembly 140 according to the detected result of the detecting element 164, for example, control the pin 152 to get away from the rolling wheel 144a, as shown in FIG. 6. At this time, since the rolling wheel 144a of the sliding assembly 140 is not interfered by the pin 152 of the stopping assembly 150, the rolling wheel 144a may roll within the slide rail 142a, and further the rotating assembly 130 and the upper body 120 may slide relative to the lower body 110 through the sliding assembly 140, as shown in FIG. 3 to FIG. 4, thereby switching the using mode is achieved.

The electromagnetic element 162 and the detecting element 164 adopted in the trigger assembly 1602 may automatically drive the stopping assembly 150 to fix or release the sliding assembly 140 through an electric drive, however in other embodiments not shown in the drawings, the trigger assembly may also adopt mechanisms that does not require an electric drive. For example, the trigger assembly may include a restoring mechanism, e.g., an elastic element disposed on the lower body 110 and connected to the stopping assembly 150. As such, the restoring mechanism may constantly drives the stopping assembly 150 to fix the sliding assembly 140 when the upper body 120 is rotated relative to the lower body 110 through the rotating assembly 130, for example, constantly pushes the pin 152 to interfere the rolling wheel 144a due to the interference of the upper body 120, until after the upper body 120 is rotated to the predetermined angle θ and triggered by the upper body 120, for example, after the upper body 120 is rotated to the predetermined angle θ and interfering the restoring mechanism is released, the restoring mechanism releases the restoring force and drives the pin 152 to get away from the rolling wheel 144a, thereby achieving that the trigger assembly automatically driving the stopping assembly 150 to fix or release the sliding assembly 140. Accordingly, the disclosure does not limit the embodiment of the trigger assembly, it may alter according to actual requirement.

Accordingly, in the present embodiment, during the process that the upper body 120 is rotated relative to the lower body 110 through the rotating assembly 130, the sliding assembly 140 is fixed by the stopping assembly 150, and the upper body 120 and the rotating assembly 130 cannot slide relative to the lower body 110, until after the upper body 120 is rotated to the predetermined angle θ relative to the lower body 110, the trigger assembly 160 is triggered and drives the stopping assembly 150 to release the sliding assembly 140, thereby the upper body 120 and the rotating assembly 130 can then slide relative to the lower body 110 through the sliding assembly 140. Herein, the predetermined angle θ may be 180 degrees preferably, namely, the upper body 120 which is originally stacked above the lower body 110 needs to rotate to 180 degrees relative to the lower body 110 and in a horizontally expanded status (as shown in FIG. 2 to FIG. 3), after that may further slide to be stacked above the lower body 110 again through the sliding assembly 140 sliding relative to the lower body 110 (as shown in FIG. 3 through FIG. 4).

More specifically, when the user makes the upper body 120 rotate to an angle smaller than the predetermined angle θ (e.g., rotate to a 120 degree angle) relative to the lower body 110 and uses the electronic device 100 as a notebook computer, since the sliding assembly 140 is fixed by the stopping assembly 150, the upper body 120 may not do any sliding action during the process that the electronic device 100 is used as a notebook computer. After the user further makes the upper body 120 rotate to the predetermined angle θ relative to the lower body 110, the trigger assembly 160 is triggered and drives the stopping assembly 150 to release the sliding assembly 140. At this time, the user may make the upper body 120 slide relative to the lower body 110 through the sliding assembly 140 and stake thereon, so as to use the electronic device 100 as a tablet computer. As such, the rotation action and the sliding action of the upper body 120 have an execution sequence, advantaging that the electronic device 100 has a good operating method when switching among the using modes, and unexpected action may not be generated after switching the using modes.

In light of the foregoing, in the electronic device of the disclosure, the upper body may rotate relative to the lower body through the rotating assembly, and the rotating assembly is disposed on the sliding assembly, so that the rotating assembly and the upper body may slide relative to the lower body through the sliding assembly. In other words, the electronic device of the disclosure adopts the rotating assembly which can slide. Furthermore, the electronic device adopts the stopping assembly to fix the sliding assembly when the upper body rotates relative to the lower body through the rotating assembly, until the upper body is in a specific condition (e.g., after rotated to a predetermined angle), the stopping assembly is then driven to release the sliding assembly through the trigger assembly, and the upper body and the rotating assembly slide relative to the lower body through the sliding assembly. Accordingly, in the electronic device of the disclosure, the upper body and the lower body thereof may rotate and slide relatively to switch among the using modes, and the rotation action and the sliding action thereof have an execution sequence, facilitating the electronic device to have a superior operating method, not to generate unexpected action after switching the using modes.

Although the disclosure has been described with reference to the above embodiments, it will be apparent to one of ordinary skill in the art that modifications to the described embodiments may be made without departing from the spirit of the disclosure. Accordingly, the scope of the disclosure will be defined by the attached claims and not by the above detailed descriptions.

What is claimed is:

1. An electronic device, comprising:
a lower body;
an upper body, disposed above the lower body;
a rotating assembly, disposed between the upper body and the lower body, so that the upper body is pivotally disposed on the lower body;
a sliding assembly, disposed between the rotating assembly and the lower body, so that the rotating assembly is slidably disposed on the lower body; and
a stopping assembly, disposed on the lower body and corresponding to the sliding assembly, so as to fix the sliding assembly when the upper body rotates relative to the lower body through the rotating assembly and release the sliding assembly until the upper body rotates to a predetermined angle, thereafter the upper body and the rotating assembly are adapted to slide relative to the lower body through the sliding assembly.

2. The electronic device as claimed in claim 1, wherein the rotating assembly comprises:
a pair of rotating shafts, disposed on two opposite sides of the lower body, and correspondingly connected to two opposite sides of the upper body, so that the upper body is pivotally disposed on the lower body.

3. The electronic device as claimed in claim 2, wherein the sliding assembly comprises:
a pair of slide rails, disposed on two opposite side surfaces of the lower body; and
a pair of rolling wheels, disposed within the pair of slide rails, the pair of rotating shafts correspondingly connected to the pair of rolling wheels, so as to be slidably disposed on the lower body through the pair of rolling wheels are embedded into the pair of slide rails.

4. The electronic device as claimed in claim 3, wherein the sliding assembly comprises:
a pair of connecting elements, disposed on two opposite side surfaces of the lower body, the pair of rolling wheels disposed on the pair of connecting elements, and the pair of rotating shafts disposed on the pair of connecting elements, so as to correspondingly be connected to the pair of rolling wheels.

5. The electronic device according to claim 4, wherein each of the pair of rotating shafts and the corresponding rolling wheels are disposed at two opposite ends of the corresponding connecting elements.

6. The electronic device as claimed in claim 3, wherein the stopping assembly comprises:
a pair of pins, disposed on the lower body and corresponding to the pair of rolling wheels, so as to fix the sliding assembly through interfering the pair of rolling wheels when the upper body rotates relative to the lower body through the rotating assembly.

7. The electronic device as claimed in claim 1, further comprising:
a trigger assembly, disposed on the lower body and connected to the stopping assembly, wherein the trigger assembly is adapted to be triggered when the upper body rotates to the predetermined angle and drive the stopping assembly to release the sliding assembly.

8. The electronic device as claimed in claim 7, wherein the trigger assembly comprises:
a restoring mechanism, disposed on the lower body and connected to the stopping assembly, wherein the restoring mechanism constantly drives the stopping assembly to fix the sliding assembly when the upper body rotates relative to the lower body through the rotating assembly and release the sliding assembly until after the upper body rotates to the predetermined angle and triggered by the upper body.

9. The electronic device as claimed in claim 7, wherein the trigger assembly comprises:
an electromagnetic element, disposed on the lower body and connected to the stopping assembly; and
a detecting element, disposed on the lower body and connected to the electromagnetic element, so as to detect whether the upper body rotates to the predetermined angle, wherein the electromagnetic element controls the stopping assembly to fix or release the sliding assembly according to a detected result of the detecting element.

10. The electronic device as claimed in claim 1, wherein the predetermined angle comprises 180 degrees.
